(19) United States
(12) Patent Application Publication
(10) Pub. No.: US 2025/0158089 A1
(43) Pub. Date: May 15, 2025

(54) SEPARATOR PLATE FOR AN ELECTROCHEMICAL SYSTEM AND ASSOCIATED ELECTROCHEMICAL SYSTEM COMPRISING A PLURALITY OF SEPARATOR PLATES

(71) Applicant: Reinz-Dichtungs-GmbH, Neu-Ulm (DE)

(72) Inventors: Andre SPEIDEL, Bussmannshausen (DE); Bernadette GRÜNWALD, Ulm (DE); Thomas STÖHR, Laupheim (DE)

(21) Appl. No.: 18/945,308

(22) Filed: Nov. 12, 2024

(30) Foreign Application Priority Data
Nov. 13, 2023 (DE) 20 2023 106 626.7

(51) Int. Cl. H01M 8/026; C25B 9/77; C25B 13/02; H01M 8/0254; H01M 8/10

(52) U.S. Cl. CPC H01M 8/026; C25B 9/77; C25B 13/02; H01M 8/0254; H01M 2008/1095

(57) ABSTRACT

The present disclosure relates to a separator plate for an electrochemical system, comprising a first individual plate, wherein the first individual plate has, embossed on a first side, webs with web flanks that at least in sections delimit channels for guiding a first fluid, the web flanks having a first inclination relative to a plate plane, wherein the first individual plate has at least one transverse stiffening region that extends transversely to a longitudinal direction of extension of the webs and in which a second inclination of the web flanks relative to the plate plane is less than the first inclination outside the transverse stiffening region.

### CROSS REFERENCE TO RELATED APPLICATION

This application claims priority to German Utility Model Application No. 20 2023 106 626.7, entitled “SEPARATOR PLATE FOR AN ELECTROCHEMICAL SYSTEM AND ASSOCIATED ELECTROCHEMICAL SYSTEM COMPRISING A PLURALITY OF SEPARATOR PLATES”, filed Nov. 13, 2023. The entire contents of the above-identified application is hereby incorporated by reference for all purposes.

### TECHNICAL FIELD

The present disclosure relates to a separator plate for an electrochemical system and an electrochemical system comprising at least one such separator plate.

### BACKGROUND AND SUMMARY

Known electrochemical systems, for example fuel cell systems or electrochemical compressor systems, redox flow batteries and electrolyzers, usually comprise a plurality of separator plates which are arranged in a stack, such that in each case two adjacent separator plates enclose an electrochemical cell. The separator plates usually each comprise two individual plates which are connected to one another along their rear sides facing away from the electrochemical cells. The separator plates can be used, for example, for electrically contacting the electrodes of the individual electrochemical cells (e.g. fuel cells) and/or for electrically connecting adjacent cells (series connection of the cells).

The individual plates of the separator plates may comprise channel structures for supplying the cells with one or more media and/or for transporting media away from the cells. In the case of fuel cells, the media can be, for example, fuels (e.g. hydrogen or methanol), reaction gases (e.g. air or oxygen) or a coolant as supplied media, and reaction products and heated coolant as discharged media. Furthermore, the separator plates may serve for transferring the waste heat produced in the electrochemical cell, as is produced for instance during the conversion of electrical or chemical energy in a fuel cell, and may be configured to seal the various media channels or cooling channels in relation to one another and/or from the external environment. In the case of fuel cells, the reaction media, i.e. fuel and reaction gases, are normally conducted on the mutually averted surfaces of the individual plates, while the coolant is conducted between the individual plates. The bipolar plates usually have at least one or more through-openings. Through the through-openings, the media and/or the reaction products can be fed to the electrochemical cells bounded by adjacent separator plates of the stack, or into the cavity formed by the individual plates of the separator plate, or can be discharged from the cells or from the cavity. The electrochemical cells, in particular of a fuel cell, may, for example, each comprise a membrane electrode assembly (or MEA) with a respective polymer electrolyte membrane (PEM) and electrodes. The MEA can also have one or more gas diffusion layers (GDL), which are usually oriented towards the separator plates, in particular towards the separator plates of fuel cell systems and are configured, for example, as a carbon fleece. In an example fuel cell, hydrogen carried on an anode side is typically converted to water, with oxygen being carried on a cathode side. Protons produced during the oxidation of hydrogen pass from the anode side through the MEA to the cathode, where they react with the oxygen and electrons to form water. The membrane of the fuel cell is electrically insulating and prevents an electrical short circuit between the anode and cathode. The electrons are guided separately from the anode to the cathode so that the electric current can be utilized.

The individual plates of the separator plates are typically embossed to form the web and channel structures. In application fields of electrochemical systems, particularly in the automotive and aviation sectors, high demands are placed on electrochemical systems. During the embossing process, springback leads to bulging effects and therefore shape deviations. A high number of embossed webs and channels can increase this detrimental effect.

It is therefore the object of the present disclosure to propose an improved, in particular stiffened, separator plate and/or an improved electrochemical system comprising at least one such separator plate, in particular in such a way that bulging effects are reduced.

According to the present disclosure, this object is at least partially solved by a separator plate and/or an electrochemical having the features described herein.

The proposed separator plate for an electrochemical system comprises a first individual plate. The first individual plate has embossed webs with web flanks on a first side. The individual plate has channels for guiding a first fluid. The web flanks delimit the channels at least in sections; the web flanks can therefore also extend in sections into the height range that is considered to be the channel depth. The channels can also be delimited by channel bases. The web flanks have a first inclination n₁ relative to a plate plane.

The first individual plate has at least one transverse stiffening region, which extends transversely to a longitudinal direction of extension of the webs and in which a second inclination n₂ of the web flanks relative to the plate plane is less than the first inclination n₁, thus, an inclination outside of the transverse stiffening region. Typically, n₁ corresponds to the largest inclination of the web flanks.

The transverse stiffening region has the advantage that stiffening is carried out directly at the radius where springback occurs during the embossing process.

In the transverse stiffening region, the second inclination n₂ relative to the plate plane, which is less than the first inclination n₁, can decrease to a minimum value n_{2, min} along a longitudinal extension of the channels and then increase again. The inclination can, for example, gradually decrease and/or increase and/or continuously increase and/or decrease. Any steps are radiused. This may be due to the embossing process and/or be advantageous for a flow line, as turbulence can be reduced and/or avoided in this way.

The channel bottoms and/or web surfaces can, for example, lie in the plate plane or parallel to the plate plane.

For example, the first inclination n₁ can correspond to an angle greater than 50°, optionally an angle greater than 60° and less than 85°. The inclination n₂ is often reduced to values for n_{2, min} in the range of 15 to 45°. Optionally, the minimum inclination n_{2, min} is at least 15° and a maximum of 50°, in the case of a complete lowering with n_{2, min}=0 a maximum of 85° less than n₁.

In the transverse stiffening region, a web width of the webs can decrease and increase again along a longitudinal extension of the webs. It may be greater in the transverse stiffening region than in regions before and/or after the transverse stiffening region. It may be measured at T_{K} as described below with respect to the channel width.

In the transverse stiffening region, the webs can be lower along their longitudinal extension. In this way, a transverse channel can be formed that runs transversely, optionally orthogonally, to the longitudinal direction of extension, optionally in a straight line. In addition, the channel bases can be raised so that a transverse channel is created not only on the side of the first individual plate on which the webs protrude, but also on the opposite surface of the first individual plate. This makes it possible to mix the media within each of at least two separate media spaces, this may balance concentrations. In extreme cases, the second inclination n_{2, min} is reduced to 0°.

A permissible, free span of the GDL can define the width of the spacing of the web interruption resulting from the lowering. In particular, the distance can be chosen as small as possible. The distance can be at least 0.5 mm, optionally at least 0.6 mm and/or at least 0.7 mm. The distance can, for example, be a maximum of 1.5 mm, optionally a maximum of 1.4 mm and/or a maximum of 1.2 mm.

A channel depth and a web height can be considered separately. A maximum extension of the overall structure can be measured along a direction orthogonal to the plate plane between the underside of the web and the channel base. A reference line can be defined at half the height of the maximum extension between the underside of the web and the channel base. The web height can be measured along the direction orthogonal to the plate plane, starting from the reference line to the underside of the web. The channel depth can be measured along the direction orthogonal to the plate plane, starting from the reference line to the channel base. However, it is also possible that the web height and the channel depth are designed differently, for example, if the height of the channel(s) is raised to a different extent than a web is lowered within a transverse stiffening region. The reference line then may not extend at half height, but in accordance with the distances.

The maximum extension of the overall structure and/or the web height and/or the channel depth in the transverse stiffening region can deviate from the maximum extension of the overall structure and/or from the web height and/or from the channel depth outside the transverse stiffening region.

Optionally, a channel depth of the channels and/or a web height of the webs in the transverse stiffening region can deviate from the channel depth of the channels and/or from the web height of the webs in regions in the direction of flow before and/or after the transverse stiffening region. The term “before and/or after the transverse stiffening region” in the context of this application may generally mean before and/or after in the direction of flow, thus in the extension direction of the channels and/or webs.

The channel depth in the transverse stiffening region can be at least 0.2 times and/or at least 0.3 times and/or at least 0.4 times and/or at most 1.5 times and/or at most 1.3 times and/or at most 1.1 times the channel depth outside the transverse stiffening region. As described above, the channel depth outside the transverse stiffening region can be half the height of the overall structure outside the transverse stiffening region.

A channel depth of the channels can vary from channel to channel in the transverse stiffening region. Some or all channels in a transverse stiffening region can have different channel depths. Similarly, the web height of the webs can change from web to web.

Additionally or alternatively, a channel depth of the channels may vary along their longitudinal extension. Optionally, the channel depth can vary along their longitudinal extension in the transverse stiffening region, for example increasing, decreasing and increasing again. Similarly, the web height of the webs can change along their longitudinal extension.

The first individual plate can have more than one transverse stiffening region. The channel depth and/or web height can be different in at least some of the transverse stiffening regions. Optionally, an asymmetrical arrangement of the transverse stiffening regions and/or channel depths and/or web heights can be provided. This can help to optimize the flow.

A channel width of the channels in the transverse stiffening region can be smaller than in regions before and/or after the transverse stiffening region. The channel width can be measured at the reference point at half the height of the maximum expansion (hereinafter also referred to as “half height” or “T_{K}”) between the underside of the web and the channel base. Alternatively, the duct width can be measured at 0.8 times T_{K} starting from the duct floor.

The channel width at half height can be at least 0.7 mm and/or at least 0.8 mm and/or at least 0.9 mm and/or at most 3 mm and/or at most 2.9 mm and/or at most 2.8 mm. The channel width at half height can converge towards the channel base to form a radius.

A channel width of the channels measured on the channel bases as well as a web height of the webs measured on the webs in the transverse stiffening region can be greater than in regions before and/or after the transverse stiffening region.

The number of channels before the transverse stiffening region can be equal to the number of channels after the transverse stiffening region.

In a section transverse to the longitudinal direction of extension in a transverse stiffening region, each web flank can have the same second inclination n₂ relative to the plate plane, which is less than the first inclination n₁.

In a section within the transverse stiffening region that is transverse, optionally substantially orthogonal, to the longitudinal direction of extension, some or all of the channels may be formed in the same way and some or all of the webs may be formed in the same way. Optionally, the edge channels and/or webs can be different from the other channels and/or webs.

In a section outside the transverse stiffening region that is transverse, optionally substantially orthogonal, to the longitudinal direction of extension, some or all of the channels can be formed in the same way and some or all of the webs can be formed in the same way. Optionally, the edge channels and/or webs can be different from the other channels and/or webs.

The separator plate can have a distribution region, a collection region and an active region arranged fluidically between the distribution and collection regions. The transverse stiffening region can be located in the active region.

Optionally, the transverse stiffening regions are only arranged within the active region, i.e. not in the distribution or collection region.

The separator plate can comprise several transverse stiffening regions, which can be arranged one behind the other in the direction of fluid flow. The transverse stiffening regions may be regularly distributed in the direction of fluid flow.

One or more of the transverse stiffening regions can extend transversely, optionally orthogonally and/or arcuately and/or in an x-shaped and/or v-shaped and/or >-shaped and/or <-shaped manner to the longitudinal direction of extension of the channels.

At least one, optionally several, of the transverse stiffening regions can extend across the entire active region. The shapes of the transverse stiffening regions can vary. For example, an x-shaped, an arc-shaped and an orthogonally extending transverse stiffening region can be provided in an active region.

A transverse stiffening region can be arranged at least centrally in the active region. This may include a transverse stiffening region which extends over the entire width of the active region but only in a central region with respect to the longitudinal direction of extension of the channels. However, it must not extend over the entire width of the active region. It is also possible that several transverse stiffening regions are arranged in the central half or the central third of the longitudinal direction of extension of the channels

The number of transverse stiffening regions can increase towards one side of the active region, particularly in or opposite to the direction of fluid flow.

Several transverse channels are also possible, which may be formed in the middle (largest bulge) or also recurring (constant or alternating distances from each other), for example in the middle and/or towards one end of the active region. This can have advantages in terms of media distribution, especially for gas and/or coolant, and can lead to increased performance of the stack. In particular, the coolant flow can be better controlled from the outside to the inside in the top view of the plate and in the direction of flow.

The separator plate can have a second individual plate. The second individual plate can have webs embossed on a first side. The webs can have web flanks that at least in sections delimit channels for guiding a second fluid. The second individual plate can be connected to the first individual plate on a second side facing away from the first side.

The present disclosure further relates to an electrochemical system comprising a plurality of separator plates. At least one, optionally a plurality and/or all of the separator plates corresponds/correspond to the above description.

Exemplary embodiments of the separator plate and of the electrochemical system are illustrated in the figures and will be explained in more detail on the basis of the following description.

### BRIEF DESCRIPTION OF THE FIGURES

FIG. 1 schematically shows, in a perspective view, an electrochemical system comprising a plurality of separator plates arranged in a stack.

FIG. 2 schematically shows, in a perspective view, two separator plates of the system according to FIG. 1 with a membrane electrode assembly (MEA) arranged between the separator plates.

FIG. 3 schematically shows a cross-section through a plate stack of a system in the manner of the system according to FIG. 1.

FIG. 4A schematically shows a plan view of an individual plate.

FIG. 4B schematically shows the individual plate shown in FIG. 4A as a bending beam.

FIG. 5A schematic shows a perspective view of a section of an active region of an individual plate of a system of the type shown in FIG. 1.

FIG. 5B schematically shows a top view of the section shown in FIG. 5A.

FIG. 5C schematically shows a cross-section through the section shown in FIG. 5A along the section line B-B shown in FIG. 5B.

FIG. 5D schematically shows a cross-section through the section shown in FIG. 5A along the section line C-C shown in FIG. 5B.

FIG. 5E schematically shows a cross-section through the cut-out shown in FIG. 5A along the sectional line D-D shown in FIG. 5B.

FIG. 5F schematically shows a cross-section through the section shown in FIG. 5A along the section line E-E shown in FIG. 5B.

FIG. 5G schematically shows a cross-section through the cut-out shown in FIG. 5A along the section line F-F shown in FIG. 5B.

FIG. 5H schematically shows a cross-section through the section shown in FIG. 5A along the section line G-G shown in FIG. 5B.

FIG. 5I schematically shows a detail N of the cross-section shown in FIG. 5C along the section line B-B shown in FIG. 5B.

FIG. 6A schematically shows a perspective view of a section of an active region of an individual plate of a system of the type shown in FIG. 1.

FIG. 6B schematically shows a top view of the section shown in FIG. 6A.

FIG. 6C schematically shows a cross-section through the section shown in FIG. 6A along the section line K-K shown in FIG. 6B.

FIG. 6D schematically shows a cross-section through the section shown in FIG. 6A along the section line L-L shown in FIG. 6B.

FIG. 6E schematically shows a cross-section through the cut-out shown in FIG. 6A along the sectional line M-M shown in FIG. 6B.

FIG. 7A schematically shows a top view of an individual plate of a system of the type shown in FIG. 1.

FIG. 7B schematically shows a top view of an individual plate of a system of the type shown in FIG. 1.

FIG. 7C schematically shows a top view of an individual plate of a system of the type shown in FIG. 1.

FIG. 7D schematically shows a top view of an individual plate of a system of the type shown in FIG. 1.

### DETAILED DESCRIPTION

Here and below, features that recur in different figures are denoted in each case by the same or similar reference signs.

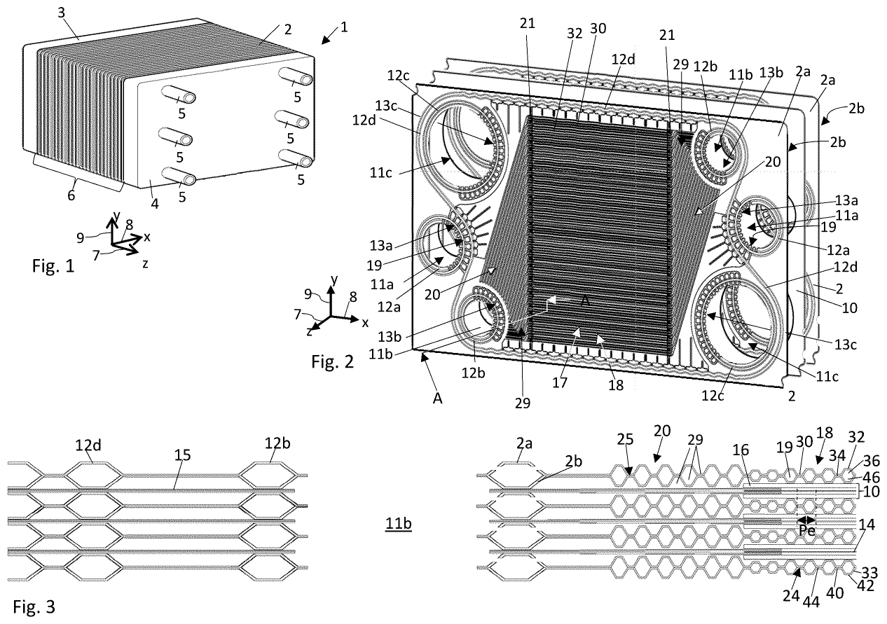

FIG. 1 shows an electrochemical system 1 comprising a plurality of structurally identical metal separator plates 2, which are arranged in a stack 6 and are stacked along a z-direction 7. The separator plates 2 of the stack 6 are clamped between two end plates 3, 4. The z-direction 7 is also referred to as the stacking direction. In the present example, the system 1 is a fuel cell stack. Two adjacent separator plates 2 of the stack enclose an electrochemical cell between them, which is used, for example, to convert chemical energy into electrical energy. To form the electrochemical cells of system 1, a membrane electrode assembly (MEA) 10 is arranged between adjacent separator plates 2 of the stack (see e.g. FIGS. 2 and 3). Each MEA 10 typically contains at least one membrane, for example an electrolyte membrane. Furthermore, a gas diffusion layer (GDL) can be arranged on one or both surfaces of the MEA, not shown in FIGS. 1 and 2 but can be seen in FIG. 3, for example.

In alternative embodiments, the system 1 may equally be in the form of an electrolyzer, an electrochemical compressor or a redox flow battery. In these electrochemical systems, use may likewise be made of separator plates. The structure of these separator plates can then correspond to the structure of the separator plates 2 described in more detail here, even if the media fed onto or through the separator plate in an electrolyzer, in an electrochemical compressor or in a redox flow battery may differ in each case from the media used for a fuel cell system. Optionally, the separator plates can each comprise exactly one individual plate.

The z-axis 7 together with an x-axis 8 and a y-axis 9 defines a right-handed Cartesian coordinate system. The separator plates 2 each define a plate plane, whereby the plate planes of the individual plates 2a, 2b are each aligned parallel to the x-y plane and thus perpendicular to the stacking direction or to the z-axis 7. The end plate 4 comprises a plurality of media connections 5, via which media can be fed to the system 1 and via which media can be discharged from the system 1. These media which can be fed to the system 1 and which can be discharged from the system 1 may comprise, for example, fuels such as molecular hydrogen or methanol, reaction gases such as air or oxygen, reaction products such as water vapor, or depleted fuels or coolants such as water and/or glycol.

FIG. 2 shows, in perspective form, two adjacent separator plates 2 of an electrochemical system of the type of the system 1 of FIG. 1 and a membrane electrode assembly (MEA) 10 known from the prior art which is arranged between these adjacent separator plates 2, the MEA 10 being largely concealed in FIG. 2 by the separator plate 2 that faces the observer. The separator plate 2 is formed from two individual plates 2a, 2b that are joined together in a materially bonded manner (see for example FIG. 3), of which only the first individual plate 2a that faces the observer and that conceals the second individual plate 2b is visible in FIG. 2. The individual plates 2a, 2b may each be manufactured from a metal sheet, e.g. from a stainless-steel sheet. The individual plates 2a, 2b may, for example, be welded to one another, e.g. by laser welded joints. On the one hand, the individual plates 2a, 2b can be tightly welded along and at a distance from their outer edges or at least along the inner edge of a part of the through-openings along sealing seams, in particular outside and/or inside the perimeter bead 12d. Further weld seams are possible, for example in the region between the channels, which will be explained later.

The individual plates 2a, 2b comprise through-openings which are aligned with one another and which form through-openings 11a-c in the separator plate 2. When a plurality of separator plates of the type of the separator plate 2 are stacked, the through-openings 11a-c form ducts which extend in the stacking direction 7 through the stack 6 (see FIG. 1). Typically, each of the ducts formed by the through-openings 11a-c is fluidically connected to one of the ports or media connections 5 in the end plate 4 of the system 1. By way of the ducts formed by the through-openings 11a, it is possible for e.g. coolant to be introduced into the stack or discharged from the stack. By contrast, the ducts formed by the through-openings 11b, 11c may be configured to supply the electrochemical cells of the fuel cell stack 6 of the system 1 with fuel and with reaction gas and to discharge the reaction products from the stack. The media-conducting through-openings 11a-11c are formed substantially parallel to the plate plane.

In order to seal the through-openings 11a-c in relation to the interior of the stack 6 and in relation to the environment, the first individual plates 2a each comprise sealing arrangements in the form of sealing beads 12a-c, which are each arranged around the through-openings 11a-c and which each completely enclose the through-openings 11a-c. The second individual plates 2b have corresponding sealing beads for sealing the through-openings 11a-c on the rear side of the individual plates 2 that face away from the viewer of FIG. 2 (not shown). Alternatively, elastomer seals can also be used.

In an electrochemically active region 18, the first individual plates 2a each have, on their side that faces the viewer of FIG. 2, a flow field 17 with structures for guiding a reaction medium along the outer side of the individual plate 2a. These structures are given in FIG. 2 by a plurality of webs 32, 42 and channels 30, 40 extending between the webs 32, 42 and bounded by the webs 32, 42. On the outer side of each of the separator plates 2, that faces the viewer in FIG. 2, the first individual plates 2a also each have a distribution and collection region 20. Distribution or collection regions 20 each comprise structures which are set up to distribute a medium introduced into the distribution region 20 from a first of the two through-openings 11b among the channels of the active region 18 or to collect or bundle a medium flowing from the active region 18 towards the second of the through-openings 11b. The fluid-guiding structures 29 of both distribution or collection regions 20 are likewise provided in FIG. 2 by webs and channels which run between the webs and which are delimited by the webs. In the following text, among distribution and collection region, only the distribution region 20 will be discussed for the sake of simplicity; the corresponding statements can equally apply to a collection region 20.

The through openings 11a-c are arranged in groups of three on each longitudinal edge, i.e. on both sides of the active region 18 in extension of the channels. Such an arrangement of the through-openings with at least one through-opening per medium per longitudinal edge is particularly space-saving. Within the active region 18, the channels of the flow field can have an essentially rectilinear course as shown or an undulating course with an essentially rectilinear macroscopic direction of extension (see DE 10 2023 207 433 A1). The flow directions of the media can all be parallel or partially parallel and partially in counterflow to each other. However, the embodiment does not provide for a cross-flow in the active region 18 or even a change in direction of more than 45° for one of the media. Optionally, the channels of the active region have a flow direction or macroscopic extension direction that corresponds to the x-direction of the Cartesian coordinate system.

The sealing beads 12a-12c have passages 13a-13c, which allow passage of medium between the associated through-openings 12a-12c and the respective distribution region 20 on one gas side or in the interior of the separator plate 2.

The first individual plates 2a also each comprise a further sealing arrangement in the form of a perimeter bead 12d that runs around the flow field 17 of the active region 18, the distribution and collection regions 20 and the through-openings 11b, 11c and seals them off from the through-opening 11a, i.e. from the coolant circuit, and from the environment of the system 1. The second individual plates 2b each comprise corresponding perimeter beads. The structures of the active region 18, the distribution structures of the distribution and collection region 20 and the sealing beads 12a-d are each formed integrally with the individual plates 2a and molded into the individual plates 2a or 2b, e.g. in an embossing or deep-drawing process or by means of hydroforming.

The separator plate 2 is formed from two individual plates, namely individual plates 2a, 2b, which are joined together with a material bond (see e.g. FIG. 3), of which only the first individual plate 2a facing the viewer is visible in FIG. 2, which conceals the second individual plate. The individual plates may each be formed of a shaped metal sheet, for example a stamped or deep-drawn stainless-steel sheet. This metal sheet may have, for example, a thickness of at most 150 μm, optionally at most 100 μm, optionally at most 70 μm, or optionally at most 50 μm. The individual plates may be welded to one another, for example by laser-welded joints.

FIG. 3 schematically shows a cross-section through a portion of the plate stack 6 of the system 1 from FIG. 1, the cross-section plane being oriented in the z-direction and thus perpendicular to the plate planes of the separator plates 2. In FIG. 3, the cross-section plane runs along an offset section, along the sectional line A-A in FIG. 2. It should be noted that the separator plates in FIG. 3 are schematic and exemplary and serve to illustrate the structure of the electrochemical system, in particular the different layers and regions.

On its side that faces away from the second individual plate 2b, the first individual plate 2a has integral, adjacent first channels 30 for guiding the media, which are separated from one another by first webs 32 formed between the first channels 30. On a side of the first individual plate 2a that faces the second individual plate 2b, the first channels 30 form first protrusions 34 and the first webs 32 form first grooves 36. On its side that faces away from the first individual plate 2a, the second individual plate 2b has integral second channels 40 running next to one another for guiding the media, which are separated from one another by second webs 42 formed between the second channels 40. Here, on a side of the second individual plate 2b that faces the first individual plate 2a, the second channels 40 form second protrusions 44 and the second webs 42 form second grooves 46.

Cooling channels are arranged in the cavity 19 between adjacent individual plates 2a, 2b. In the active region 18, the two individual plates 2a, 2b rest on each other in a contact region 24. The individual plates 2a and 2b can be connected to each other there.

The first channels 30 and first webs 32 of the first individual plate 2a have the same period length Pe as the second channels 40 and second webs 42 of the second individual plate 2b. This is also preferred for the subsequent separator plates 2, even if only individual plates 2a, 2b are shown here.

A membrane electrode assembly (MEA) 10 known from the prior art, for example, is arranged between adjacent individual plates 2 of the stack. The MEA 10 typically comprises a membrane 14, e.g. an electrolyte membrane, and an edge portion 15 connected to the membrane 14. For example, the edge portion 15 can be bonded to the membrane 14, e.g. by an adhesive connection or by lamination.

In the present case, the term “electrochemically active region” is used to designate the region of the individual plate 2a, 2b that is opposite an electrochemically active region of the MEA 10 when the individual plate 2a, 2b is arranged in an electrochemical system. The membrane of the MEA 10 extends in each case at least over the active region 18 of the adjacent separator plates 2 and enables a proton transfer there over or through the membrane 14. The actual active region 18 is limited by the edge portion 15 of the MEA. This means that the membrane does not extend into the distribution or collection region 20. The edge portion 15 of the MEA 10 serves in each case for positioning, fastening and sealing the membrane between the adjoining separator plates 2.

The edge portion 15 in each case covers the distribution or collection region 20 of the adjoining separator plates 2. The edge portion 15 can also extend outwards beyond the perimeter bead 12d and adjoin or protrude beyond the outer edge region of the individual plates 2a, 2b (see FIG. 2).

Furthermore, gas diffusion layers 16 may additionally be arranged in the active region 18. The gas diffusion layers 16 enable flow of gas to the membrane 14 over the largest possible region of the membrane surface and can thus improve the proton transfer across the membrane 14. The gas diffusion layers 16 can, for example, be arranged on both sides of the membrane 14 at least in the active region 18 between the adjacent separator plates 2. The gas diffusion layers 16 may be, for example, formed from a fiber felt or comprise a fiber felt.

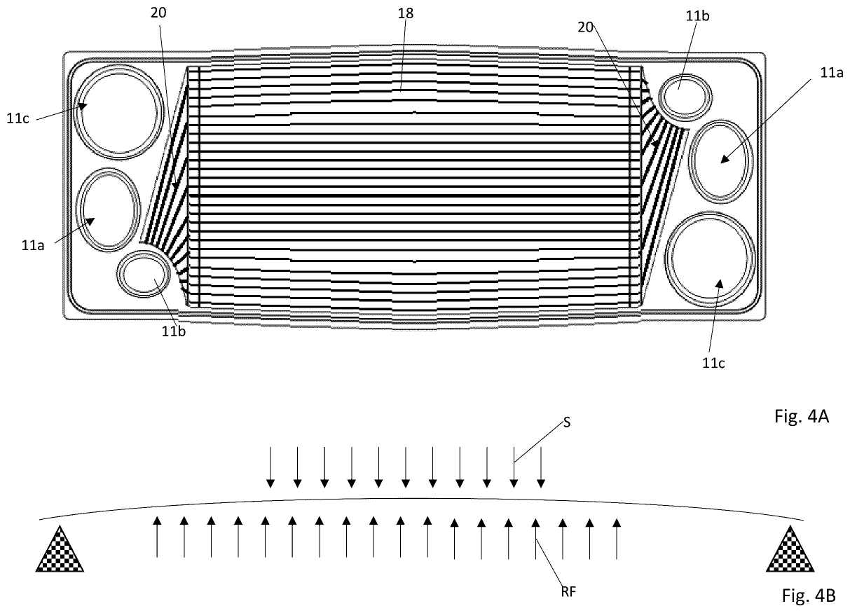

FIG. 4A shows a schematic top view of an exemplary individual plate of the prior art for a separator plate of an electrochemical system. FIG. 4B shows the individual plate of FIG. 4A schematically as a bending beam. In FIG. 4B, the springback RF, thus the relaxation of material after releasing it from the shaping tool, of the active region on the one hand and the stiffness S of the bending beam on the other hand are visualized by arrows. In the active region, compressive stresses that are present in the separator plate or that result from the manufacturing process lead to bulging effects that cause problems when the separator plates are used in an electrochemical system of the type shown in FIG. 1. These bulging effects can, for example, result in elements of the separator plate no longer fitting together with the elements of the MEA interacting with them or, in the case of two-layer separator plates, the elements of the individual plates being geometrically displaced relative to each other. Furthermore, the tools required for the subsequent processing steps may no longer fit. Difficulties can also arise during stacking. If this is only counteracted by stiffening the edge regions of the separator plates, this usually results in undesirable creases, so that this is not an effective countermeasure. The present disclosure has the object of counteracting these bulging effects.

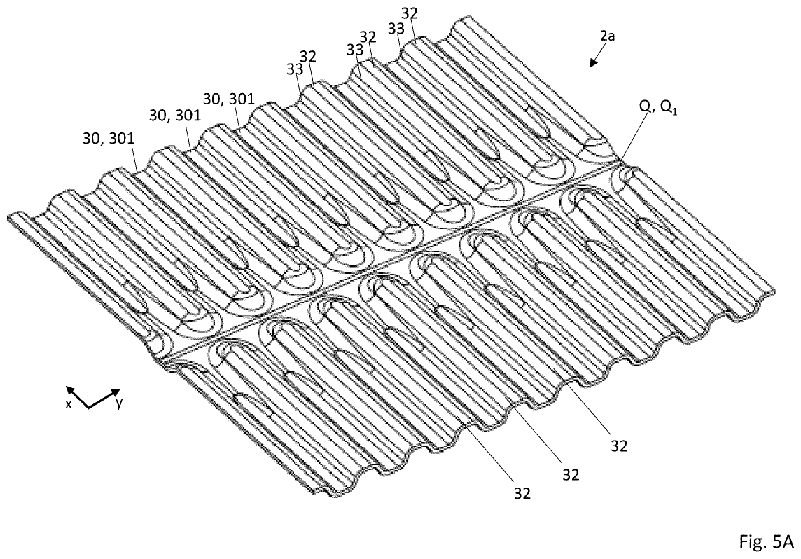

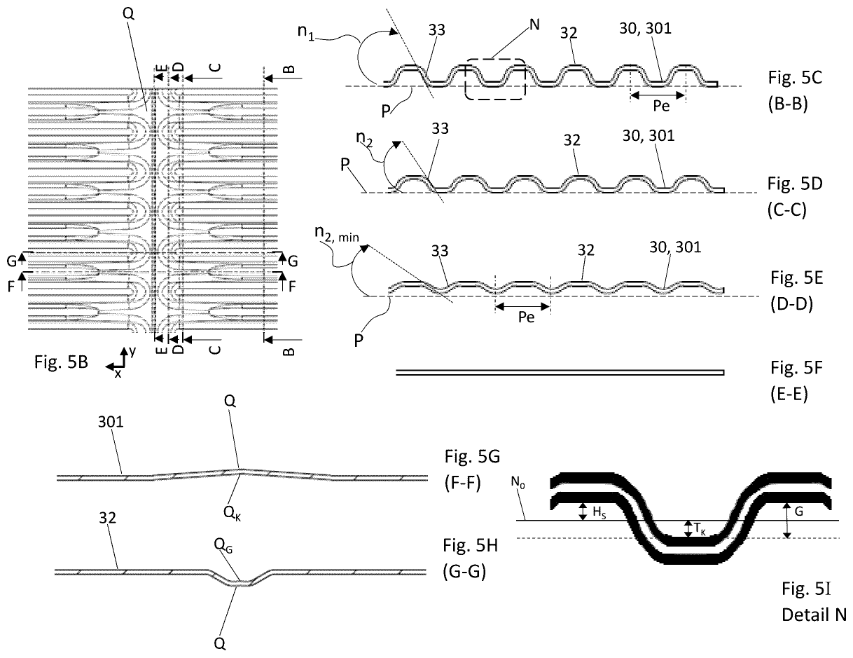

FIG. 5A shows a section of the active region 18 of an individual plate 2a of a separator plate 2 of a system of the type shown in FIG. 1.

The first individual plate 2a has webs 32 embossed on a first side. The webs have web flanks 33. The web flanks 33 laterally delimit channels 30 for guiding a first fluid. The channels are further, namely at their bottom, delimited by the channel bases 301.

For the sake of clarity, only some of the elements, for example webs, web flanks, channels and channel bases, are marked with the respective reference symbols in this figure, the previous and the following figures.

The first individual plate 2a has at least one transverse stiffening region Q, which extends transversely to a longitudinal direction of extension of the webs 32. The transverse stiffening region shown extends orthogonally to the longitudinal direction of extension of the webs 32 and extends over the entire width of the section shown, optionally over the entire width of the active region of the first individual plate 2a.

Outside the transverse stiffening region Q, the web flanks 33 have a first inclination n₁ relative to a plate plane P. In the transverse stiffening region Q, the web flanks 33 have a second inclination n₂ relative to the plate plane P. The second inclination n₂ is less than the first inclination n₁. The plate plane P extends parallel to the x-y plane.

FIG. 5B shows a top view of the section in FIG. 5A. FIG. 5B shows cross-sections B-B to G-G, which are visualized in the following FIGS. 5C to 5H. The cross-section B-B (FIG. 5C) is orthogonal to the longitudinal direction of extension of the webs 32 in a region outside the transverse stiffening region Q. Here, all web flanks 33 have the same inclination n₁.

FIG. 5I shows detail N of cross-section B-B of FIG. 5C.

This shows a channel depth T_{K} and a web height H_{S}. A maximum extension of the overall structure G can be measured along a direction orthogonal to the plate plane between the underside of the web and the channel floor. A reference line No can be defined at half the height of the maximum extension G between the underside of the web and the channel base. The web height H_{S} can be measured along the direction orthogonal to the plate plane P, starting from the reference line N₀ to the underside of the web. The channel depth T_{K} can be measured along the direction orthogonal to the plate plane P, starting from the reference line N₀ to the channel base. Pe represents the period of channels and webs perpendicular to the flow direction x.

FIG. 5D shows cross-section C-C. Cross-section C-C lies in the transverse stiffening region Q. The channel depth T_{K} is less in the region of cross-section C-C than in the region of cross-section B-B. FIG. 5E shows cross-section D-D. Cross-section D-D is orthogonal to the plate plane P and orthogonal to the longitudinal direction of extension of the webs 32. The channel depth T_{K} is less in the region of cross-section D-D than in the region of cross-section C-C. The inclination n₂ of the web flanks 33 is approximately 30° in cross-section D-D, which is less than in cross-section C-C, where the flank angle is approximately 50°, and less than in cross-section B-B, where the flank inclination n₁ corresponds to a flank angle of approximately 75°. In the transverse stiffening region, the second inclination n₂ decreases and increases again in relation to the plate plane P along the longitudinal extension of the channels 30.

FIG. 5F shows the cross-section E-E, which lies in the transverse stiffening region Q. The cross-section E-E is orthogonal to the plate plane P and orthogonal to the longitudinal direction of extension of the webs 32. The inclination n₂ of the web flanks 33 is zero in cross-section E-E and thus corresponds to the minimum value n_{2, min}, so that no webs 32 are formed in this region; instead, a transverse channel Q_{G} is formed orthogonally to the longitudinal direction of extension of the webs 32. FIG. 5G visualizes cross-section F-F, which intersects the section shown in FIG. 5B along the longitudinal extension direction of a channel 30. In the transverse stiffening region Q, the channel bases 301 are raised, rising at an angle of between 5° and 15°, in this case approximately 7°. This results in a cross channel Q_{K} for the medium guided on the underside, for example, for cooling medium. In the regions outside the transverse stiffening region Q, the channels have a constant channel depth T_{K}. FIG. 5H visualizes cross-section G-G, which intersects the section shown in FIG. 5B along the longitudinal direction of extension of a web 32. In the transverse stiffening region Q, the webs 32 are lowered to form the transverse channel Q_{G}, but here the lowering bases run at an angle of approx. 30°. In the region outside the transverse stiffening region Q, the webs have a constant web height H_{S}. The transverse channel Q_{G} in FIG. 5 is rectilinear and runs parallel to the y-axis. In other examples, the transverse channel can have a different shape, for example be arched, wavy or x-shaped. The number of webs 32 and channels 30 in the flow direction upstream of the transverse stiffening region Q corresponds to the number of webs 32 and channels 30 downstream of the transverse stiffening region Q.

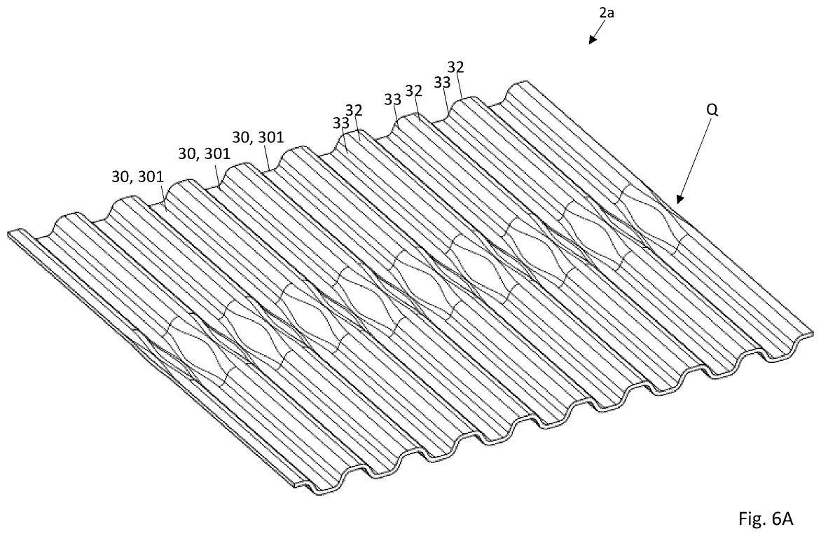

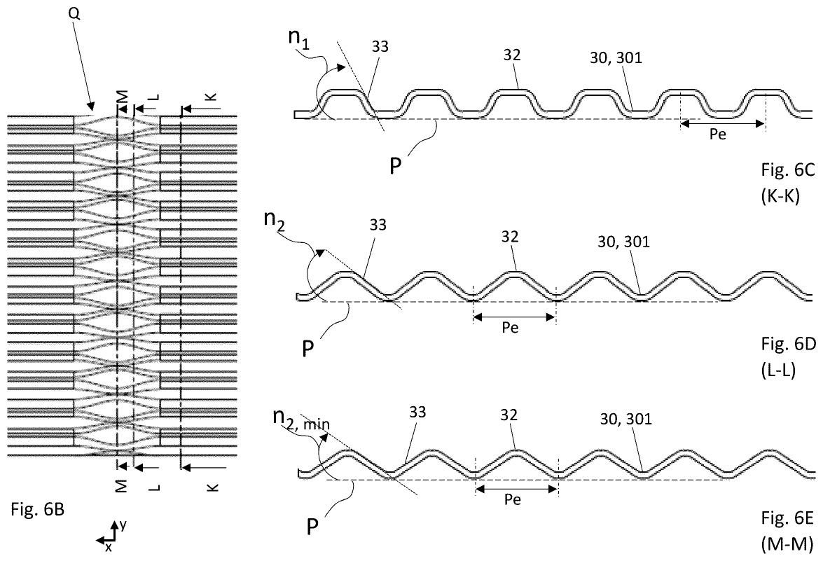

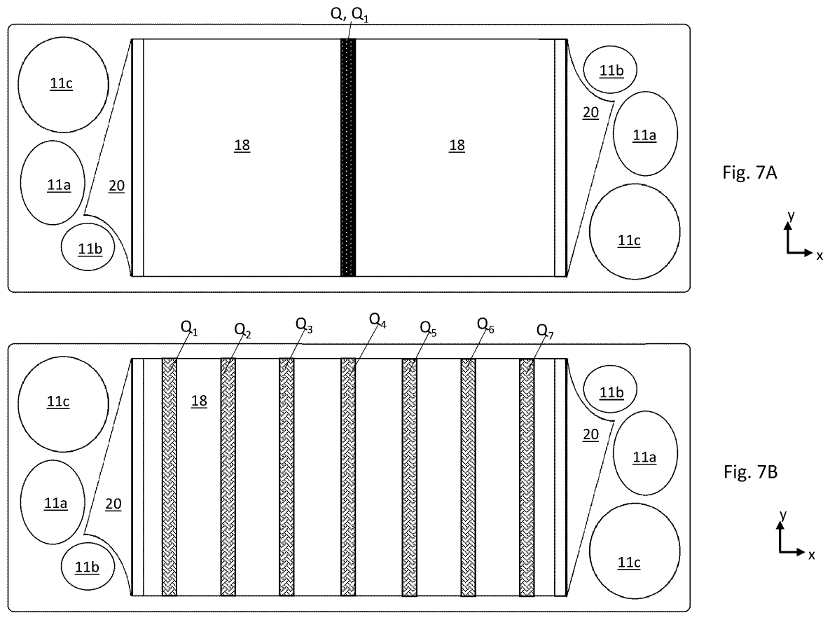

FIG. 6A shows a section of the active region 18 of an individual plate 2a of a separator plate 2 of a system of the type shown in FIG. 1.

The first individual plate 2a has webs 32 embossed on a first side. The webs have web flanks 33. The web flanks 33 laterally delimit channels 30 for guiding a first fluid. The channels are further delimited by the channel bases 301. The first individual plate 2a has at least one transverse stiffening region Q, which extends transversely to a longitudinal direction of extension of the webs 32. The transverse stiffening region Q shown extends orthogonally to the longitudinal direction of extension of the webs 32 and extends over the entire width of the section shown, optionally over the entire width of the active region of the first individual plate 2a. Outside the transverse stiffening region Q, the web flanks 33 have a first inclination n₁ relative to a plate plane P. In the transverse stiffening region Q, the web flanks 33 have an inclination n₂ or n_{2, min} relative to the plate plane P that is less than the first inclination n₁. The inclination n_{2, min} is lower than the other inclinations n₂. The plate plane P extends parallel to the x-y plane.

FIG. 6B shows a top view of the section in FIG. 6A. FIG. 6B shows cross-sections K-K, L-L and M-M, which are visualized in the following FIGS. 6C to 6E. Cross-sections K-K, L-L and M-M intersect the shown section of the individual plate 2a orthogonally to the longitudinal direction of the webs 32. Cross-section K-K lies outside the transverse stiffening region Q, while cross-sections L-L and M-M lie within the transverse stiffening region Q. In the direction of flow, a web width of the webs decreases and increases again in the transverse stiffening region Q along a longitudinal extension of the webs 32. However, in the section shown in FIG. 6, the webs 32 are continuous along their longitudinal extent and are not interrupted. The flank inclination decreases steadily from cross-section K-K to cross-section M-M. For example, the flank angle n₁ is 70°, the flank angle n₂ in the region of section cross-L-L is approximately 50° and the flank angle n₂, mil is approximately 30°. Cross-section M-M (FIG. 6E) lies in the transverse direction to the transverse stiffening region and thus in this case along the longitudinal extension of the webs 32 in the middle of the transverse stiffening region and shows the region of the smallest web width of the webs 32. In cross-section L-L, which lies in front of cross-section M-M in the direction of flow, the web width of the webs is wider than in cross-section M-M and smaller than in cross-section K-K, which lies outside the transverse stiffening region Q. The channels are narrower in the transverse stiffening region Q than in regions before and after the transverse stiffening region Q, wherein the height is measured at 0.8 times the channel depth starting from the channel base 301. The channel width of the channels 33 measured on the webs in the transverse stiffening region Q is greater than in regions before and/or after the transverse stiffening region Q.

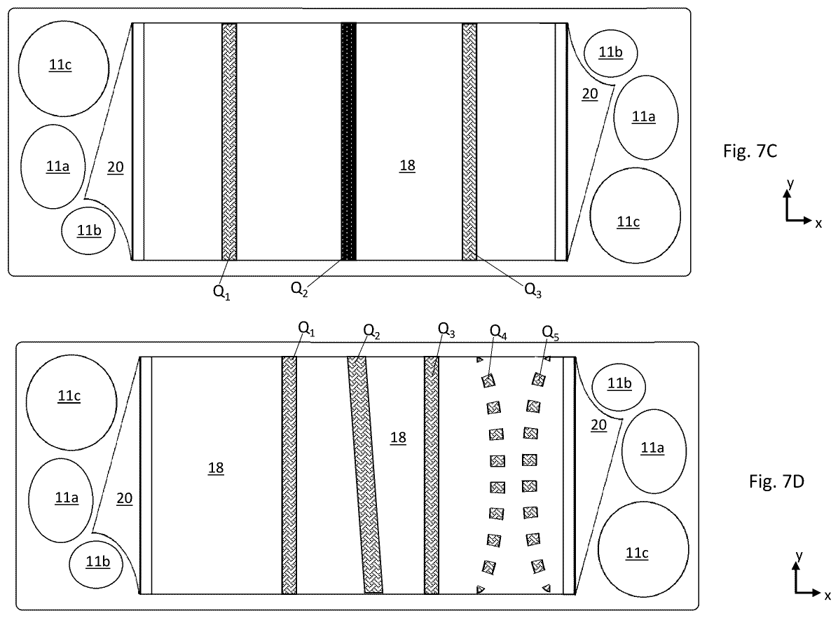

FIGS. 7A to 7D each show a top view of an exemplary individual plate 2a of a system of the type shown in FIG. 1.

The individual plate of FIG. 7A comprises two distribution/collection regions 20 and an active region 18 arranged fluidically between the two distribution/collection regions 20. A transverse stiffening region Q is located in the active region 18. The transverse stiffening region Q can be configured as described above. This transverse stiffening region Q extends parallel to the y-direction and is arranged centrally in the active region in the direction of flow. The present transverse stiffening region Q extends across the entire active region 18 in the y-direction.

The individual plate of FIG. 7B comprises two distribution/collection regions 20 and an active region 18 arranged fluidically between the two distribution/collection regions 20. Seven transverse stiffening regions Q₁ to Q₇ are located in the active region 18. The transverse stiffening regions Q₁ to Q₇ can be configured as described above. The transverse stiffening regions Q₁ to Q₇ extend parallel to the y-direction. The transverse stiffening regions Q₁ to Q₇ can all be of the same design, for example all as described in FIG. 5. In particular, the transverse stiffening regions Q₁ to Q₇ can have a distance between the transition between an inclination n₂ and the inclination n₁ of the transverse stiffening region Qₓ and the transition between the inclination n₁ and the inclination n₂ of the next transverse stiffening region Qₓ₊₁, which corresponds to at least twice, at least three times, at least five times, or at least ten times the period length Pe. Alternatively, the transverse stiffening regions Q₁ to Q₇ can be formed differently, for example some can be formed as described in FIG. 5 and some as described in relation to FIG. 6. The transverse stiffening regions Q₁ to Q₇ are arranged parallel to each other and evenly spaced across the active region 18. The transverse stiffening regions Q₁ to Q₇ in the y-direction extend across the entire active region 18.

The individual plate of FIG. 7C comprises two distribution/collection regions 20 and an active region 18 arranged fluidically between the two distribution/collection regions 20. Three transverse stiffening regions Q₁ to Q₃ are located in the active region 18. The transverse stiffening regions Q₁ to Q₃ can be configured as described above. The transverse stiffening regions Q₁ to Q₃ extend parallel to the y-direction. The transverse stiffening regions Q₁ to Q₃ can all be of the same design, for example all as described in FIG. 5. Alternatively, the transverse stiffening regions Q₁ to Q₃ can be designed differently, for example the transverse stiffening region Q₂ can be designed as described in FIG. 5 and the transverse stiffening regions Q₁ and Q₃ can be designed as described in relation to FIG. 6. The transverse stiffening regions Q₁ to Q₃ are arranged parallel to each other and evenly spaced across the active region 18. The transverse stiffening regions Q₁ to Q₃ extend in the y-direction across the entire active region 18.

The individual plate of FIG. 7D comprises two distribution/collection regions 20 and an active region 18 arranged fluidically between the two distribution/collection regions 20. Five transverse stiffening regions Q₁ to Q₅ are located in the active region 18. The transverse stiffening regions Q₁ to Q₅ are all located in two thirds of the area of the active region 18. The transverse stiffening regions Q₁ to Q₅ can be configured as described above. The transverse stiffening regions Q₁ and Q₃ extend parallel to the y-direction. The transverse stiffening regions Q₄ and Q₅ are arranged in an arc, whereby the transverse stiffening region Q₄ is convex and the transverse stiffening region Q₅ is concave. The transverse stiffening regions Q₄ and Q₅ have interruptions, while the transverse stiffening regions Q₁ to Q₃ are continuous. Some or all of the transverse stiffening regions Q₁ to Q₅ can be configured in the manner shown in FIG. 5 or in the manner shown in FIG. 6. The transverse stiffening region Q₂ is arranged at an angle to the x-axis.

1. A separator plate for an electrochemical system, comprising a first individual plate, wherein
the first individual plate has, embossed on a first side, webs with web flanks that at least in sections delimit channels for guiding a first fluid, the web flanks having a first inclination relative to a plate plane,
wherein the first individual plate has at least one transverse stiffening region that extends transversely to a longitudinal direction of extension of the webs and in which a second inclination of the web flanks relative to the plate plane is less than the first inclination.

2. The separator plate according to claim 1, wherein, in the transverse stiffening region, the second inclination relative to the plate plane, which is less than the first inclination, decreases along a longitudinal extension of the channels to a minimum value and increases again.

3. The separator plate according to claim 1, wherein, in the transverse stiffening region, a web width of the webs decreases along a longitudinal extension of the webs and increases again.

4. The separator plate according to claim 1, wherein, in the transverse stiffening region, the webs are lower along an elongate extension of the webs, so that a transverse channel extending transversely to the elongate extension is formed.

5. The separator plate according to claim 1, wherein a channel depth of the channels in the transverse stiffening region deviates from the channel depth of the channels in regions before and/or after the transverse stiffening region and/or a web height of the webs in the transverse stiffening region deviates from the web height of the webs in regions before and/or after the transverse stiffening region.

6. The separator plate according to claim 1, wherein a channel depth of the channels in the transverse stiffening region varies from channel to channel and/or a web height of the webs in the transverse stiffening region varies from channel to channel.

7. The separator plate according to claim 1, wherein a channel depth of the channels and/or a web height of the webs varies along their longitudinal extension.

8. The separator plate according to claim 1, wherein the first individual plate has more than one transverse stiffening region and a channel depth and/or web height is different in at least some of the transverse stiffening regions.

9. The separator plate according to claim 1, wherein a channel width of the channels measured at 0.8 T_{K} in the transverse stiffening region is smaller than in regions before and/or after the transverse stiffening region.

10. The separator plate according to claim 1, wherein a web width of the webs measured on the webs in the transverse stiffening region is greater than in regions before and/or after the transverse stiffening region.

11. The separator plate according to claim 1, wherein the number of channels before the transverse stiffening region is equal to the number of channels after the transverse stiffening region.

12. The separator plate according to claim 1, wherein, in a section transverse to the longitudinal direction of extension, each web flank has the same second inclination relative to the plate plane, which is less than the first inclination.

13. The separator plate according to claim 1, wherein, in a section within the transverse stiffening region and/or outside the transverse stiffening region, transversely to the longitudinal direction of extension, the channels are formed in the same way and the webs are formed in the same way.

14. The separator plate according to claim 1, comprising a distributing and collecting region and an active region arranged fluidically between the distributing and collecting region, wherein the transverse stiffening region is located in the active region.

15. The separator plate according to claim 14, comprising a plurality of transverse stiffening regions which are arranged one behind the other in a direction of fluid flow, wherein the number of transverse stiffening regions increases towards one side of the active region.

16. The separator plate according to claim 1, wherein one or more of the transverse stiffening regions extends transversely to the longitudinal direction of extension of the channels.

17. The separator plate according to claim 14, wherein at least one of the transverse stiffening regions extends transversely over the entire active region.

18. The separator plate according to claim 14, wherein the transverse stiffening region is arranged at least centrally in the active region.

19. The separator plate according to claim 1, having a second individual plate, the second individual plate having embossed, on a first side, webs with channels that at least in sections delimit web flanks for guiding a second fluid and being connected to the first individual plate on a second side facing away from the first side.

20. An electrochemical system comprising a plurality of separator plates according to claim 1.
